(19) United States
(12) Patent Application Publication
(10) Pub. No.: US 2026/0070218 A1
(43) Pub. Date: Mar. 12, 2026

(54) REAL-TIME LOCALIZATION AND POSE CORRECTION OF A ROBOT

(71) Applicant: Field AI, Inc., Mission Viejo, CA (US)

(72) Inventors: Matteo PALIERI, Laguna Beach, CA (US); David Fan, Lake Forest, CA (US); Connor LAM, Mission Viejo, CA (US); Chanyoung CHUNG, Santa Ana, CA (US)

(73) Assignee: Field AI, Inc., Mission Viejo, CA (US)

(21) Appl. No.: 19/326,825

(22) Filed: Sep. 12, 2025

Related U.S. Application Data
(60) Provisional application No. 63/693,833, filed on Sep. 12, 2024.

(51) Int. Cl. B25J 9/16

(52) U.S. Cl. CPC B25J 9/1653; B25J 9/161; B25J 9/163

(57) ABSTRACT

Systems and methods for real-time localization and pose correction of a robot are provided. An example system may obtain sensor data of a localized environment, odometry data indicating the robot's movement in the localized environment, and environmental data including a global two-dimensional model depicting a global environment. The system may generate a localized three-dimensional model depicting the localized environment, and generate a localized two-dimensional model of the localized environment based upon transforming the localized three-dimensional model. The system may obtain an indication of an estimated pose of the robot in the localized environment, perform a registration of the localized two-dimensional model with the global two-dimensional model based upon the estimated pose, and generate corrected pose data indicating a corrected pose of the robot. The system may configure the robot using the corrected pose data to identify the corrected pose of the robot within the global environment.

### CROSS-REFERENCE TO RELATED APPLICATION

This application claims priority to and the benefit of the filing date of provisional U.S. Patent Application No. 63/693,833, entitled “SYSTEM AND METHOD FOR REAL-TIME POSE ESTIMATION AND CORRECTION OF ROBOTS” and filed on Sep. 12, 2024, the entire contents of which is hereby expressly incorporated herein by reference.

### TECHNICAL FIELD

The implementations of the present disclosure relate to robotic localization systems, and specifically to a system and a method for real-time localization and pose correction of a robot.

### BACKGROUND

Robots have become increasingly prevalent in complex and dynamic environments such as industrial facilities and construction sites to automate various tasks and improve operational efficiency. However, for robots to operate (e.g., semi-autonomously, autonomously) in the complex and dynamic environments, accurate localization is crucial. Localization refers to a robot's ability to determine its pose, which may include its location, position, and/or otherwise orientation within its surroundings.

Traditional localization methods rely on a Global Positioning System (GPS), which may be unreliable and unavailable in indoor environments or areas with obstructed sky views. Other approaches may use visual markers or beacons, but the visual markers or beacons require additional infrastructure and maintenance. As a result, there is a growing need for robust, infrastructure-free localization solutions that may work effectively in industrial and construction settings.

One challenge in robot localization is dealing with odometry drift. Odometry estimates a robot's position based on wheel rotations, inertial measurements, or other locomotive indications but tends to accumulate errors over time. Odometry drift may lead to significant positioning inaccuracies, especially in the complex and dynamic environments.

Another consideration in robot localization is the condition of industrial and construction environments. The industrial and construction environments may range from open spaces with few distinguishing features to cluttered areas with numerous obstacles. The traditional localization methods fail to handle diverse environmental conditions and adapt to changes in the surroundings.

In light of the ever-growing adoption of robots in the industrial and construction applications, there is need for systems and methods that provide efficient, reliable, and versatile robotic localization solutions. Therefore, there is a need for innovative approaches that address the aforementioned short-comings and disadvantages of conventional robotic localization systems and methods.

### SUMMARY

In one general aspect, the instant disclosure describes a system for real-time localization and pose correction of a robot. The system may include one or more processors; and one or more memories having stored thereon processor-executable instructions that, when executed by the one or more processors, cause the one or more processors to: obtain (i) sensor data indicating one or more characteristics of a localized environment, (ii) odometry data indicating movement of the robot while traversing the localized environment; and (iii) environmental data including a global two-dimensional model that depicts a global environment from an aerial perspective, wherein: the localized environment is at least a portion of the global environment, and the localized environment is localized respective to the robot as it generates the sensor data while traversing the localized environment; generate a localized three-dimensional model depicting the localized environment based upon the sensor data and the odometry data; generate a localized two-dimensional model of the localized environment that depicts the localized environment from the aerial perspective based upon transforming the localized three-dimensional model; obtain an indication of an estimated pose of the robot in the localized environment depicted by the localized two-dimensional model; perform a registration of the localized two-dimensional model with the global two-dimensional model based upon the estimated pose of the robot, wherein the registration generates a transformation function associated with aligning the localized two-dimensional model and the global two-dimensional model; generate corrected pose data indicating a corrected pose of the robot in the localized environment based upon the transformation function; and configure the robot using the corrected pose data to identify the corrected pose of the robot within the global environment that differs from the estimated pose.

In another general aspect, the instant disclosure describes a computer-implemented method for real-time localization and pose correction of a robot. The computer-implemented method may include obtaining, by one or more processors: (i) sensor data indicating one or more characteristics of a localized environment, (ii) odometry data indicating movement of the robot while traversing the localized environment; and (iii) environmental data including a global two-dimensional model that depicts a global environment from an aerial perspective, wherein: the localized environment is at least a portion of the global environment, and the localized environment is localized respective to the robot as it generates the sensor data while traversing the localized environment; generating, by the one or more processors, a localized three-dimensional model depicting the localized environment based upon the sensor data and the odometry data; generating, by the one or more processors, a localized two-dimensional model of the localized environment that depicts the localized environment from the aerial perspective based upon transforming the localized three-dimensional model; obtaining, by the one or more processors, an indication of an estimated pose of the robot in the localized environment depicted by the localized two-dimensional model; performing, by the one or more processors, a registration of the localized two-dimensional model with the global two-dimensional model based upon the estimated pose of the robot, wherein the registration generates a transformation function associated with aligning the localized two-dimensional model and the global two-dimensional model; generating, by the one or more processors, corrected pose data indicating a corrected pose of the robot in the localized environment based upon the transformation function; and configuring, by the one or more processors, the robot using the corrected pose data to identify the corrected pose of the robot within the global environment that differs from the estimated pose.

In another general aspect, the instant disclosure describes a non-transitory computer-readable medium storing processor-executable instructions that, when executed by one or more processors, may cause the one or more processors to at least: obtain (i) sensor data indicating one or more characteristics of a localized environment, (ii) odometry data indicating movement of a robot while traversing the localized environment; and (iii) environmental data including a global two-dimensional model that depicts a global environment from an aerial perspective, wherein: the localized environment is at least a portion of the global environment, and the localized environment is localized respective to the robot as it generates the sensor data while traversing the localized environment; generate a localized three-dimensional model depicting the localized environment based upon the sensor data and the odometry data; generate a localized two-dimensional model of the localized environment that depicts the localized environment from the aerial perspective based upon transforming the localized three-dimensional model; obtain an indication of an estimated pose of the robot in the localized environment depicted by the localized two-dimensional model; perform a registration of the localized two-dimensional model with the global two-dimensional model based upon the estimated pose of the robot, wherein the registration generates a transformation function associated with aligning the localized two-dimensional model and the global two-dimensional model; generate corrected pose data indicating a corrected pose of the robot in the localized environment based upon the transformation function; and configure the robot using the corrected pose data to identify the corrected pose of the robot within the global environment that differs from the estimated pose.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a block diagram depicting an example computing environment for real-time localization and pose correction of a robot, in one implementation of the instant application.

FIG. 2 is a block diagram depicting an example training process of a machine learning model, in one implementation of the instant application.

FIG. 3A is a block diagram of an exemplary workflow for real-time localization and pose correction of a robot, in one implementation of the instant application.

FIG. 3B depicts an example global two-dimensional model of an example global environment for performing real-time localization and pose correction of a robot, in one implementation of the instant application.

FIG. 3C depicts an example localized environment for generating an example localized three-dimensional model, in one implementation of the instant application.

FIG. 3D depicts an example model of an example localized environment for generating an example localized three-dimensional model using machine learning, in one implementation of the instant application.

FIG. 3E depicts an example composite two-dimensional model for performing an example registration, in one implementation of the instant application.

FIG. 4 is a flow diagram depicting an example computer-implemented method for real-time terrain classification in one implementation of the instant application.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well-known methods, procedures, components, and/or circuitry have been described at a relatively high-level, without detail, in order to avoid unnecessarily obscuring aspects of the present teachings.

The disclosed systems and methods provide real-time localization and pose correction of a robot. An example system may obtain sensor data, odometry data, and environmental data. The sensor data may indicate characteristics of a localized environment. The localized environment (e.g., hallway) may be a portion of a global environment (e.g., a building) that is local to the robot as it generates the sensor data while traversing the localized environment. The sensor data may include point cloud data, images, and/or other suitable data indicating localized environmental characteristics. The odometry data may indicating movement of the robot while traversing the localized environment. The environmental data may include a global two-dimensional model (e.g., point cloud) that depicts the global environment from an aerial perspective.

The system may generate a localized three-dimensional model (e.g., three-dimensional point cloud) depicting the localized environment based upon the sensor data and the odometry data. The system may generate a localized two-dimensional model (e.g., two-dimensional point cloud) by transforming the localized three-dimensional model. The localized two-dimensional model may depict the localized environment from the aerial perspective. In at least some implementations, the two-dimensional model may only represent particular objects of the localized environment, such as objects located within particular spatial distances (e.g., heights) respective to the robot, objects have particular classifications (e.g. structural object), etc. The system may obtain (e.g., from a user, via pose estimation techniques) an indication of an estimated pose of the robot in the localized environment depicted by the localized two-dimensional model. Based upon the estimated pose, the system may perform a registration of the localized two-dimensional model with the global two-dimensional model. The registration may generate a transformation function associated with aligning the localized two-dimensional model and the global two-dimensional model. Based upon the transformation function the system may generate corrected pose data indicating a corrected pose of the robot in the localized environment. The system may configure the robot using the corrected pose data, causing the robot to identify its corrected pose (e.g., location, orientation) within the global environment, which may include identifying and/or compensating for odometry drift.

The disclosed systems and methods address the aforementioned shortcomings of conventional robotic localization and pose correction systems and technologies by providing real-time localization and pose correction that is to adapt to unknown and/or complex operational environments while compensating for issues like odometry drift, among others. For example, the system may allow the robot to be placed in an unknown global environment, such as a building. Based upon gathering sensor and odometry data of a localized environment such as a few hallways and rooms of the building (e.g., the global environment) the robot can generate one or more models of its localized environment, such as two-dimensional point clouds that only contain structure information (e.g., identity walls) and/or otherwise eliminate objects that may be of minimal use for localization (e.g., plants). Based upon initial estimated pose information (e.g., received from a user based upon comparing models of the local and global environments) which may not be entirely accurate, the robot can perform a registration using the localized two-dimensional model and a two-dimensional model of global environment. For example, initial pose estimation may indicate the robot is in an upper right quadrant of the global an environment. The robot may then compare and register (e.g., using iterative closest point techniques) the localized two-dimensional point cloud and the global two-dimensional point cloud of the upper right quadrant of the building. The transformation function used for the registration may be used to determine the correct pose of the robot. The robot may generate pose correction data that, once used to configure the robot, allows the robot to be aware of its correct pose in the global environment including identifying and compensating for odometry drift, which is not possible in conventional systems. Further, positioning technologies like GPS that may be unreliable in complex or indoor environments, are not required.

The disclosed system and methods improve the operation of localization and pose correction systems. In one example, the system is able to perform localization using two-dimensional models depicting aerial views of an environment. Two-dimensional models are less complex and contain less information as compared to their three-dimensional model counterparts. By converting three-dimensional models to simpler two-dimensional models according to the disclose techniques, the inventive systems can use fewer compute resources than required for three-dimensional models, such as less memory to process the smaller two-dimensional models compared to three-dimensional models, less powerful compute resources to process the two-dimensional models (e.g., for registration), less network bandwidth to transmit the two-dimensional model data, etc. Moreover, the causes the functionalities required to perform real-time localization and pose correction to be provided on less powerful computing hardware, such as a robot that is able to perform its localization and pose-correction on-board rather than relying on remote system such as compute resource heavy servers or distributed computing systems.

In at least some implementations, a machine learning model may perform classification of objects in the environment, so environmental models can be generated that only depict objects relevant for localization, such as structural elements, causing the environmental models (e.g., two-dimensional point cloud) to be lightweight. The machine learning model may be a student model trained by knowledge distillation from knowledge of a more powerful, but more compute resource-intensive teacher machine learning model, such that the student model can be deployed and implement on less resource intensive hardware such as the robot. Such a framework further reduces the compute resource requirements for performing real-time localization and pose correction.

In sum, the disclosed system and methods provide improvements to the operation of real-time localization and pose correction systems, and the technology/technical field of real-time localization and pose correction as just described. Such improvements advancement the field of real-time localization and pose correction respective to conventional techniques, which can require compute resource intensive intrastate and frameworks (e.g., GPS, servers), provide inaccurate pose information unable to account for odometry drift, and are generally unadaptable to complex or unknown environments, among other things.

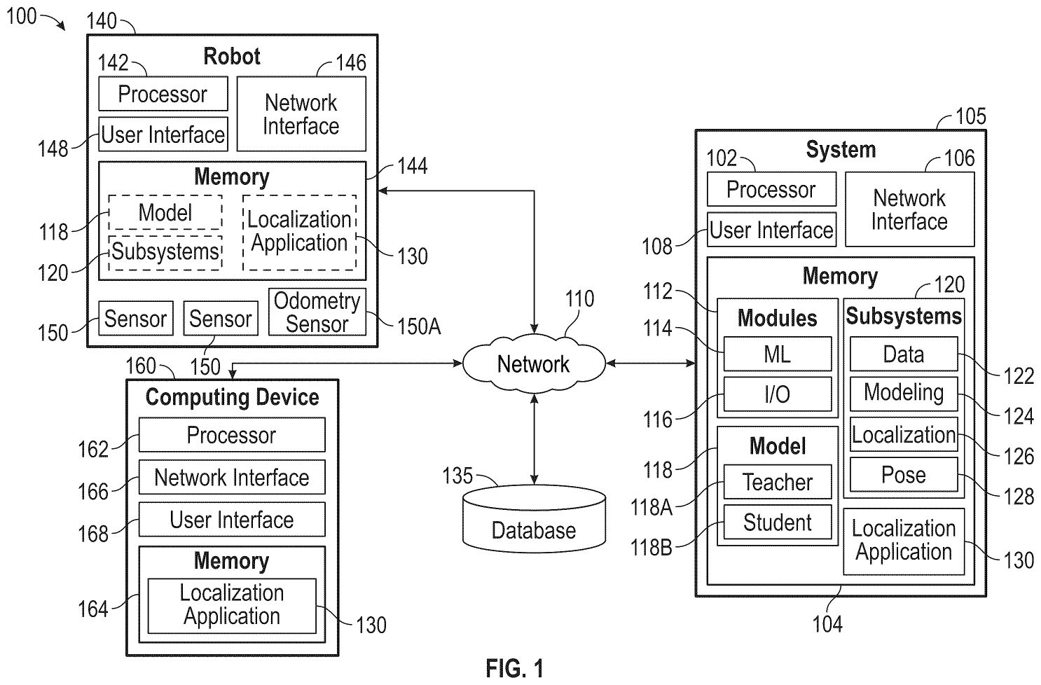

FIG. 1 is a block diagram depicting an example computing environment 100 for real-time localization and pose correction of a robot, in one implementation of the instant application. The computing environment 100 may include a system 105 communicatively coupled, via a network 110, to a database 135, a robot 140, and a computing device 160. Although FIG. 1 depicts certain entities, components, equipment, and devices, it should be appreciated that fewer, additional and/or alternate entities, components, equipment, and/or devices may be envisioned.

The system 105 may perform functionalities associated with localization and pose correction of the robot 140, such as obtaining data (e.g., sensor data, odometry data, environmental data), generating models (e.g., point clouds), configuring the robot 140, training and/or implementing a model (e.g., a machine learning model), etc. The system 105 may include, and or be part of, a cloud network or may otherwise communicate with other hardware or software components within one or more cloud computing environments to send, retrieve, or otherwise analyze data or information described herein. For example, in certain aspects of the present techniques, the computing environment 100 may include an on-premise computing environment, a multi-cloud computing environment, a public cloud computing environment, a private cloud computing environment, and/or a hybrid cloud computing environment. For example, an entity (e.g., a robotics company) may host one or more services in a public cloud computing environment (e.g., Alibaba Cloud®), Amazon Web Services® (AWS), Google Cloud®, IBM Cloud®, Microsoft Azure®, etc.). The public cloud computing environment may be a traditional off-premise cloud (i.e., not physically hosted at a location owned/controlled by the entity). Alternatively, or in addition, aspects of the public cloud may be hosted on-premises at a location owned/controlled by the entity. The public cloud may be partitioned using visualization and multi-tenancy techniques and may include one or more infrastructure-as-a-service (IaaS) and/or platform-as-a-service (PaaS) services.

The system 105 may include at least one processor 102. The processor 102 may include one or more computational circuits, including, but not limited to, one or more central processing units (CPUs), microprocessor units, microcontrollers, complex instruction set computing (CISC) microprocessor units, reduced instruction set computing microprocessor (RISC) units, very long instruction word microprocessor units, explicitly parallel instruction computing microprocessor units, graphics processing units (GPUs), digital signal processing (DPS) units, or any other type of processing circuit. The processor 102 may also include embedded controllers, such as generic or programmable logic devices or arrays, application-specific integrated circuits (ASICs), single-chip computers, and the like. The processor 102 may be connected to a memory 104 via a computer bus (not depicted) responsible for transmitting electronic data, data packets, and/or otherwise electronic signals to and from the processor 102 and the memory 104 in order to implement or perform the machine-readable instructions, methods, processes, elements, or limitations, as illustrated, depicted, or described for the various flowcharts, illustrations, diagrams, figures, and/or other disclosure herein. The processor 102 may interface with the memory 104 via a computer bus to execute an operating system and/or computing instructions contained therein, and/or to access other services/aspects. For example, the processor 102 may interface with the memory 104 via the computer bus to create, read, update, delete, or otherwise access or interact with the data stored in the memory 104 and/or the database 135.

The system 105 may include at least one network interface 106. The network interface 106 may allow the system 105 to communicate over the network 110, for example via any suitable wired and/or wireless connection. The network interface 106 may include one or more hardware, firmware, and/or software components (e.g., Ethernet cards, Wi-Fi adapters, cellular modems). The network interface 106 may include one or more transceivers (e.g., wireless wide area network (WWAN), wireless local area network WLAN, and/or wireless personal area network (WPAN) transceivers) functioning in accordance with IEEE® standards, 3GPP® standards, and/or other standards, and that may be used in receipt and transmission of data (e.g., via external/network ports connected to the network 110).

The system 105 may include at least one user interface 108. The user interface 108 may include one or more components and/or devices to receive an input and/or generate an output. The user interface 108 may include one or more of a keyboard, a mouse, a display (e.g., liquid crystal display (LCD), organic light-emitting diode (OLED) display), a touchscreen, a microphone, a speaker, an imaging device, a button, a switch, and/or other suitable components or device for to receiving an input and/or generating an output.

The memory 104 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), compact disks, digital video disks, diskettes, magnetic tape cartridges and/or other hard drives, flash memory, MicroSD® cards, and others. The memory 104 may store an operating system (e.g., Microsoft Windows®, Linux®, UNIX®, etc.) capable of facilitating the functionalities, apps, methods, or other software as discussed herein. In general, a computer program or computer based product, application, or code (e.g., ML models or other computing instructions described herein) may be stored on a machine-readable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor 102 (e.g., working in connection with the respective operating system in memory 104) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang®, Python®, C®, C++ R, C#®, Objective-C®, Java®, Scala®, ActionScript®, JavaScript®, HTML®, CSS®, XML®, etc.).

The memory 104 may store at least one computing module 112. The computing module 112 may be implemented as respective sets of computer-executable instructions (e.g., one or more source code libraries) as described herein. A component or device (standalone, client or distributed computer or computing system) configured by an application may constitute a computing module 112, also referred to herein at times interchangeably as a “subsystem” or “module,” that is configured and operated to perform certain operations. In one implementation, the computing module 112 may be implemented mechanically or electronically. The computing module 112 may include dedicated circuitry or logic that is permanently configured (within a special-purpose processor) to perform certain operations. In another implementation, the computing module 112 may also include programmable logic or circuitry (as encompassed within a general-purpose processor or other programmable processor) that is temporarily configured by software to perform certain operations. Accordingly, the term computing module 112 should be understood to encompass a tangible entity, be that an entity that is physically constructed permanently configured (hardwired) or temporarily configured (programmed) to operate in a certain manner and/or to perform certain operations described herein.

The computing module 112 may include an ML module 114. The ML module 114 may perform ML model training and/or operation. In at least some implementations, at least one of a plurality of ML methods and algorithms may be applied by the ML module 114, which may include, but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various implementations, the implemented ML methods and algorithms are directed toward at least one of a plurality of categorizations of ML, such as supervised learning, unsupervised learning, and reinforcement learning. In one aspect, the ML based algorithms may be included as a library or package executed on the system 105. For example, libraries may include the TensorFlow® based library, the PyTorch® library, and/or the scikit-learn Python® library.

In one implementation, the ML module 114 employs supervised learning, which involves identifying patterns in existing data to make predictions about subsequently received data. Specifically, the ML module 114 is “trained” using training data, which includes exemplary inputs and associated exemplary outputs. Based upon the training data, the ML module 114 may generate a predictive function which maps outputs to inputs and may utilize the predictive function to generate ML outputs based upon data inputs. The exemplary inputs and exemplary outputs of the training data may include any of the data inputs or ML outputs described above. In the exemplary implementations, a processing element may be trained by providing it with a large sample of data with known characteristics or features.

In another implementation, the ML module 114 may employ unsupervised learning, which involves finding meaningful relationships in unorganized data. Unlike supervised learning, unsupervised learning does not involve user-initiated training based upon exemplary inputs with associated outputs. Rather, in unsupervised learning, the ML module 114 may organize unlabeled data according to a relationship determined by at least one ML method/algorithm employed by the ML module 114. Unorganized data may include any combination of data inputs and/or ML outputs as described above.

In yet another implementation, the ML module 114 may employ reinforcement learning, which involves optimizing outputs based upon feedback from a reward signal. Specifically, the ML module 114 may receive a user-defined reward signal definition, receive a data input, utilize a decision-making model to generate the ML output based upon the data input, receive a reward signal based upon the reward signal definition and the ML output, and alter the decision-making model so as to receive a stronger reward signal for subsequently generated ML outputs. Other types of ML may also be employed, including deep or combined learning techniques.

The ML module 114 may include a set of computer-executable instructions implementing ML training (e.g., model creation, fine-tuning, retraining, etc.). The ML module 114 may access one or more repositories (e.g., the database 135) or any other data source for training data suitable to generate and/or otherwise train one or more ML models. The training data may be sample data with assigned relevant and comprehensive labels (classes or tags) used to fit the parameters (weights) of an ML model with the goal of training it by example. In one aspect, once an appropriate ML model is trained and validated to provide accurate predictions and/or responses, the trained model may be loaded into ML module 114 at runtime to process input data and generate output data.

The ML module 114 may receive labeled data at an input layer of a model having a networked layer architecture (e.g., an artificial neural network, a convolutional neural network, etc.) for training the one or more ML models. The received data may be propagated through one or more connected deep layers of the ML model to establish weights of one or more nodes, or neurons, of the respective layers. Initially, the weights may be initialized to random values, and one or more suitable activation functions may be chosen for the training process. The present techniques may include training a respective output layer of the one or more ML models. The output layer may be trained to output a prediction, for example.

The ML module 114 may include a set of computer-executable instructions implementing ML loading, configuration, initialization and/or operation functionality. The ML module 114 may include instructions for storing trained models (e.g., in the database 135). As discussed, once trained, the one or more trained ML models may be operated in inference mode, whereupon when provided with de novo input that the model has not previously been provided, the model may output one or more predictions, classifications, etc., as described herein.

While various implementations, examples, and/or aspects disclosed herein may include training and generating one or more ML models for the system 105 to load at runtime, it is also contemplated that one or more appropriately trained ML models may already exist (e.g., stored in the database 135, on the robot 140) such that the system 105 may load an existing trained ML model at runtime. It is further contemplated that the system 105 may retrain, fine-tune, update and/or otherwise alter an existing ML model before and/or after loading the model at runtime. Accordingly, one device (e.g., the system 105) of the computing environment 100 may train the ML model while another device (e.g., the robot 140) may execute the ML model.

The computing module 112 may include an input/output (I/O) module 116, including a set of computer-executable instructions implementing communication functions. The I/O module 116 may include a communication component configured to communicate (e.g., send and receive) data via one or more external/network port(s) to one or more components (e.g., the user interface 108), networks (e.g., the network 110) devices (e.g., the robot 140 and/or the computing device 160) as described herein. I/O module 116 may further include or implement an operator interface configured to present information to an administrator or operator and/or receive inputs from the administrator and/or operator (e.g., via the user interface 108). The I/O module 116 may facilitate I/O components (e.g., ports, capacitive or resistive touch sensitive input panels, keys, buttons, lights, LEDs), which may be directly accessible via, or attached to, the system 105 or may be indirectly accessible via or attached to another device (e.g., the computing device 160).

The memory 104 may include at least one machine learning (ML) model 118. The ML model 118 may include a routine ML model, or other element stored in memory 104 may be referred to as receiving an input, producing or storing an output, or executing, the routine, model, or other element. The ML model 118 may be executing as instructions on the processor 102. Further, those of skill in the art will appreciate that the ML model 118 be stored in the memory 104 as executable instructions, which instructions the processor 102 may retrieve from the memory 104 and execute. Further, the processor 102 should be understood to retrieve from the memory 104 any data necessary to perform the executed instructions (e.g., data required as an input to ML model 118), and to store in the memory 104 the intermediate results and/or output of any executed instructions.

The ML model 118 may include a teacher model 118A and a student model 118B. The teacher model may be trained (e.g., using model training data) and/or otherwise configured to classify objects, such as objects indicated in images, point clouds, maps, and/or other models of an environment of the robot 140. The student model 118B may be trained or otherwise configured using knowledge distillation of the knowledge of the teacher model 118A such that the student model 118B may perform at least some of the object classifications the teacher model 118A is trained to perform, such as classifying objects indicated in sensor data.

The memory 104 may include one or more subsystems 120. The subsystems 120 may include a data-obtaining subsystem 122, a modeling subsystem 124, a localization subsystem 126, and a pose subsystem 128. In at least some implementations, a goal of the subsystems 120 may be to perform localization and pose correction allowing the robot 140 to move with accuracy through an environment, avoid obstacles, and perform tasks. By continuously processing updates associated with the movement of the robot 140, the system 105 may allow the robot 140 to respond dynamically to changes in its surroundings and maintain optimal navigation paths for its operations.

The data-obtaining subsystem 122 may be configured to obtain data, such as sensor data, odometry data, environmental data, and/or any other suitable data. The sensor data and/or odometry data may be generated by the robot 140 via one or more the sensors 150, as further described here. The sensor data may indicate one or more characteristics of an environment local to the robot, referred to herein at times as the “the localized environment.” The localized environment may be a portion of a larger, global environment. For example, the localized environment may be the room the robot 140 is traveling through as it generates the sensor data and the odometry data, and the global environment may be the entire floor of the building in which the room is located. The odometry data may indicate movement of the robot 140 while traversing the localized environment. The environmental data may include data associated with the global environment that the robot 140 is operating in, such as a three-dimensional model (e.g., building information model (BIM), point cloud) or two-dimensional model (e.g., BIM, point cloud, map etc.) of the global environment such as a building. The BIM may provide a detailed and accurate digital representation of one or more structures or physical components of the global environment, including architectural features such as walls, doors, and columns that may be used for purposes of object classification, localization, registrations, and/or other suitable purpose.

The modeling subsystem 124 may be configured to perform one or more functions associated with modeling the environment of the robot 140, such as a localized environment and/or the global environment. The modeling subsystem 124 may be configured to process spatial information (e.g., point clouds) to identify structural elements relevant for localization, such as the walls, the columns, and other vertical features. The modeling subsystem 124 may filter information associated with one or more models, such as applying height filtering to exclude from the three-dimensional point cloud portions of the environment that are beyond and/or below particular heights respective to the robot. For example, the height filtering may exclude objects from the three-dimensional model that are above 8 feet like ceilings and below 6 inches like floors. The removed objects may not contribute significantly to determining the position the robot 140 in the environment, and cause models of the environment to contain less data due than if the objects were included, which may in turn conserve memory, allow the models to be processed using less powerful computing resources and/or provide faster processing of the models, etc. The modeling subsystem 124 may generate, transform, or otherwise convert various types of models, such as point clouds and maps. Foer example, the modeling subsystem 124 may converts the three-dimensional model of the environment into a two-dimensional model, referred to at times as a “Bird's Eye View” (BEV) model, depicting the environment from an aerial, top-down perspective. By transforming a three-dimensional model onto a two-dimensional plane (e.g., aligned with a gravity vector), the modeling subsystem 124 may simplifies complex three-dimensional information into a two-dimensional representation that retains all critical structural features while reducing the size of the model and/or allow for processing of the two-dimensional model with computing resources otherwise unable to process a three-dimensional model.

The modeling subsystem 124 may be configured to generate one or more models of the environment, such as models based upon data (e.g., images, point clouds, odometry data) obtained from sensors 150 of the robot, a BIM of the environmental data, and/or other suitable data. For example, the robot 140 may traverse a global environment and generate point cloud data, allowing the modeling subsystem 124 to generate a BIM, blueprint, map, or otherwise model (e.g., two-dimensional BEV model, three-dimensional model) of the environment. In another example, the modeling subsystem 124 may extract features of the BIM to generate a model of the environment. One or more models generated by the modeling subsystem 124 may serve as a reference (e.g., global environment reference) for comparison against the current environmental perception (e.g. localized environment information) of the robot 140.

The modeling subsystem 124 may register two or more models with one another, for example by aligning a localized model (e.g., point cloud) generated from real-time sensor data of the robot 140 with a global model of the environment. The registration may ensure the robot 140 can accurately determine its pose (e.g., location, orientation) within the building, even identify and/or compensate for any drift or errors (e.g., odometry drift) associated with the pose of the robot 140.

The localization subsystem 126 may be configured to determine the precise location of the robot 140 within an environment based upon comparing, aligning, and/or otherwise registering localized modeling of the environment and global modeling of the environment, and/or in any other suitable manner. For example, the localization subsystem 126 may compare a two-dimensional BEV model of the localized environment generated based upon the sensor data and the odometry data generated by the robot 140, with a two-dimensional BEV model of the global environment generated based upon a BIM. The localization subsystem 126 may perform an alignment, also referred to herein as registration, between the two-dimensional BEV models using point cloud matching techniques (e.g., iterative closest point (ICP)) and/or other suitable registration techniques. Based upon the registration, the localization subsystem 126 may determine the exact pose (e.g., location, position, and/or otherwise orientation) of the robot 140 within the environment.

The pose subsystem 128 may be configured to correct and/or otherwise adjust the pose (e.g., position, orientation, etc.) of the robot 140 based upon alignment information received from the localization subsystem 126. For example, the localized two-dimensional model may be registered with the global two-dimensional model based upon the estimated pose of the robot 140 (e.g., an estimate pose received based upon user feedback). The registration may generate a transformation function associated with aligning the localized two-dimensional model and the global two-dimensional model, and a corrected pose of the robot 140 in the localized environment may be generated based upon the transformation function. The pose subsystem 128 may generate corrected pose data indicating the corrected pose, and configure the robot 140 using the corrected pose data allowing the robot 140 to identify its corrected pose within the global environment. By correcting or otherwise compensating for discrepancies in pose, the pose subsystem 128 may also be able to determine whether drift has occurred, for example due to inaccuracies in the odometry data. The pose subsystem 128 can ensure the localized (e.g., onboard the robot 140) understanding of the pose of the robot 140 in the environment remains accurate over time which may be essential for maintaining precise navigation paths, avoiding collisions, mitigating or eliminating navigation errors, etc. Further, the pose subsystem 128 may continuously monitor the reliability of a pose information and in doing so, continuously assesses the quality of the odometry data and/or determine whether the robot should be reconfigured based upon new pose information which may or may not be reliable. For example, the system 105 (e.g., via the pose subsystem 128) may calculate a registration confidence metric indicating a confidence of the registration of the localized two-dimensional model with the global two-dimensional model. If the registration confidence metric exceeds a registration confidence metric threshold (e.g., indicating an acceptable confidence in the accuracy of the registration) the pose subsystem 128 may configure the robot 140 with the corrected pose data to correct the pose of the robot 140. However, if the registration confidence metric does not exceed the registration confidence metric threshold (e.g., indicating the accuracy of the registration may be unacceptable), the pose subsystem 128 may refrain from configuring the robot using the corrected pose data.

The memory 104 may store a localization application 130. The localization application 130 may cause the system 105 to perform one or more functions associated with localization and/or pose correction (e.g., in real-time) of the robot 140, such as implementing the one or more of the ML model 118 and/or subsystems 120; generating, analyzing, storing, and/or otherwise processing data (e.g., sensor data, odometry data, models), configuring and/or communicating with the robot 140, communicating (e.g., via the network 110) with other devices and/or components of the computing environment 100 (e.g., the system 105, the network 110, the computing device 160).

The network 110 may generally enable bidirectional communication between devices and/or components of the computing environment 100, such as the system 105, the database 135, the robot 140, and/or the computing device 160. The network 110 may be, and/or include, one or more wired communication networks and/or a wireless communication networks. The wired communication network may include one or more Ethernet connections, Fiber Optics, Power Line Communications (PLCs), Serial Communications, Coaxial Cables, Quantum Communication, Advanced Fiber Optics, Hybrid Networks, and the like. The wireless communication network may include one or more of wireless fidelity (Wi-Fi), cellular networks (e.g., fourth generation (4G), fifth generation (5G), sixth generation (6G), Bluetooth®, ZigBee®, long-range wide area network (LoRaWAN), satellite communication, radio frequency identification (RFID), internet-of-things (IoT) networks, mesh networks, non-terrestrial networks (NTNs), near field communication (NFC), and the like. The network 110 may include any suitable network or networks, including a local area network (LAN), wide area network (WAN), Internet, and/or combination thereof. In one aspect, the network 110 may include a cellular base station, such as cellular tower(s), communicating to the one or more components of the computing environment 100 via wired/wireless communications based upon any one or more of various mobile phone standards, including Global System for Mobile Communications® (GSM), Code Division Multiple Access® (CDMA), Universal Mobile Telecommunications System® (UMTS), Long Term Evolution® (LTE), Ultra-Wideband® (UWB), and/or the like. Additionally, or alternatively, the network 110 may include one or more routers, wireless switches, or other such wireless connection points communicating to the components of the computing environment 100 via wireless communications based upon any one or more of various wireless standards, including by non-limiting example, IEEE® 802.11 a/ac/ax/b/c/g/n (Wi-Fi), Bluetooth®, and/or the like.

The robot 140 may be configured to perform one or more tasks within an environment, such as a building or structure, including tasks such as localization and/or pose correction (e.g., in real-time) to be able to successfully operate within the environment. The robot 140 may be, or include, one or more off a quadruped, a wheeled robot, a biped, a drone, an unmanned arial vehicle (UAV), or an unmanned terrestrial vehicle (UTV), and/or other suitable robot. The robot 140 may include a processor 142 (e.g., the processor 102) a memory 104 (e.g., the memory 104), a network interface 146 (e.g., the network interface 106), and/or a user interface 148 (e.g., the user interface 108). The memory 144 may include one or more the ML model 118, the subsystems 120, and/or the localization application 130, however such components may be optional and thus are indicated in FIG. 1 using dashed lines. The localization application 130 of the robot 140 may include the same, or similar, functionality as the localization application 130 of the system 105.

The robot 140 may include one or more sensors 150. The sensors 150 may include, but are not restricted to, one or more imaging sensors (e.g., camera, complementary metal-oxide-semiconductor (CMOS), light detection and ranging (LIDAR), radio detection and ranging (RADAR), infrared (IR)), chemical sensors (e.g., oxygen, carbon dioxide), pressure sensors, navigation sensors (e.g., global position system (GPS), inertial measurement unit (IMU)), gyroscopes, accelerometers), proprioceptive sensors, environmental sensors (e.g., humidity, temperature, wind, ultra-violet (UV)), and/or any other suitable sensor. The one or more sensors 150 may capture sensor data that may indicate and/or otherwise be associated with sensing one or more characteristics of the physical environment of the robot 140 and/or the robot 140 itself. In one example, the one or more sensors 150 may include a camera configured to capture sensor data including images and/or video of the environment and a LIDAR sensor configured to capture LIDAR sensor data including one or more point clouds of the environment.

The sensors 150 may include one or more odometry sensors 150A (e.g., wheel encoders, LIDAR, IMU, accelerometers, gyroscopes, optical sensors, potentiometers, Hall effect sensors, cameras) for generating odometry data associated estimating the robot's position, orientation, and/or otherwise pos) by tracking the movement of the wheels, actuators, and/or other locomotive components of the robot 140 over time. For example, the odometry sensors 150A may monitor the rotation of wheels or tracks of the robot 140 to estimate (e.g., via the a localization subsystem 126, the localization application 130) the distance traveled, direction of movement, trajectory, and/or speed of the robot 140 to provide a relative position of the robot 140 based upon its initial starting point. The odometry data may be critical for understanding the movement dynamics of the robot 140 and assists in estimating its position or other localization functions, allowing the robot 140 to understand the environment and maintain awareness of its location within that space.

The robot 140 may be configured to operate (e.g., navigate, perform tasks) autonomously without intervention (e.g., input, feedback, control, etc., from another device and/or user), semiautonomous with at least some intervention, and/or anything therebetween. For example, in implementations where the robot 140 may operate autonomously, the robot 140 may execute the localization application 130 to perform a task that includes traversing an environment and requires the robot 140 to have an understating of its pose within the environment by executing one or more of the ML model 118, the subsystems 120, the localization application 130, etc., to perform localization and/or pose correction. In another example where the robot 140 may operate semiautonomously, the robot 140 may execute the localization application to perform localization and/or pose correction that includes receiving feedback, input, and/or otherwise data from a user (e.g., via the user interface 148, from a remote user of the computing device 160), from the system 105 (e.g., terrain classification preformed at the system 105), such that the robot 140 may not execute and/or the memory 144 may not include one or more of the ML model 118, the subsystems 120, and/or the localization application 130, as indicated by the associated dashed lines of FIG. 1.

The computing environment 100 may include, and/or have access to (e.g., via the network 110) the database 135. The database 135 may be a relational database, such as Oracle®, DB2®, MySQL®, a NoSQL® based database, such as MongoDB®, or another suitable database. The database 135 may store data and/or datasets include one or more types of data, records, files, etc., however, the terms “data” and “dataset” may be used interchangeably herein. In at least some implementations, the database 135 may store and/or manage data related to localization and/or pose correction, such as storing relevant data, enabling efficient data retrieval, and enabling analysis to support decision-making processes associated performing localization and/or pose correction. For example, the database 135 may be configured to store model training data, models (e.g., of the environment), robot configuration data (e.g., pose configuration data), and/or another suitable data. It should be understood that data stored in the database 135 may be stored in one or more other suitable storage components (e.g., one or more of the memories 104, 144, 164). One or more components and/or devices of the computing environment 100 (e.g., the system 105, robot 140, the computing device 160) may access the database 135 (e.g., using the localization application 130) via the network 110 for performing localization and/or pose correction. The database 135 may manage user access controls, configuration settings, and system logs, providing a comprehensive solution for data management and a security within the computing environment 100.

The computing environment 100 may include at least one computing device 160. The computing device 160 may include one or more user devices, mobile devices, smartphones, Personal Digital Assistants (PDAs), tablet computers, phablet computers, wearable computing devices, virtual reality (VR) devices, augmented reality (AR) devices, laptops, desktops, display interface panels, control panels, human machine interface panels, liquid crystal display (LCD) screens, light-emitting diode (LED) screens, and the like. The computing device 160 may include a processor 162 (e.g., the processor 102, 142) a memory 164 (e.g., the memory 104, 144), a network interface 166 (e.g., the network interface 106, 146), a user interface 168 (e.g., the user interface 108, 148). The memory 164 may include the localization application 130 including the same, or similar, functionality as the localization application 130 of the system 105 and/or robot 140. In at least some implementations, the localization application 130 may allow a user of the computing device 160 to provide input associated with localization and/or pose correction of the robot 140. For example, the user may provide input associated with an estimated pose of the robot, model training, thresholds (e.g., registration confidence threshold, height filtering thresholds), etc.

The computing environment 100 may include additional, fewer, and/or alternate components, and may be configured to perform additional, fewer, or alternate actions, including components/actions described herein. Although the computing environment 100 is shown in FIG. 1 as including one instance of various components such as the system 105, the database 135, the robot 140, and the computing device 160, various aspects include the computing environment 100 implementing any suitable number of any of the components shown in FIG. 1 and/or omitting any suitable ones of the components shown in FIG. 1. For example, model training data described as being stored in the database 135 may be stored in the memory 104 of the system 105 and therefore the database 135 may be omitted. Moreover, various aspects include the computing environment 100 including any suitable additional component(s) not shown in FIG. 1, such as but not limited to the exemplary components described above. Furthermore, it should be appreciated that additional and/or alternative connections between components shown in FIG. 1 may be implemented. As just one example, system 105 and the database 135 may be connected via a direct communication link (not shown in FIG. 1) instead of, or in addition to, via the network 110.

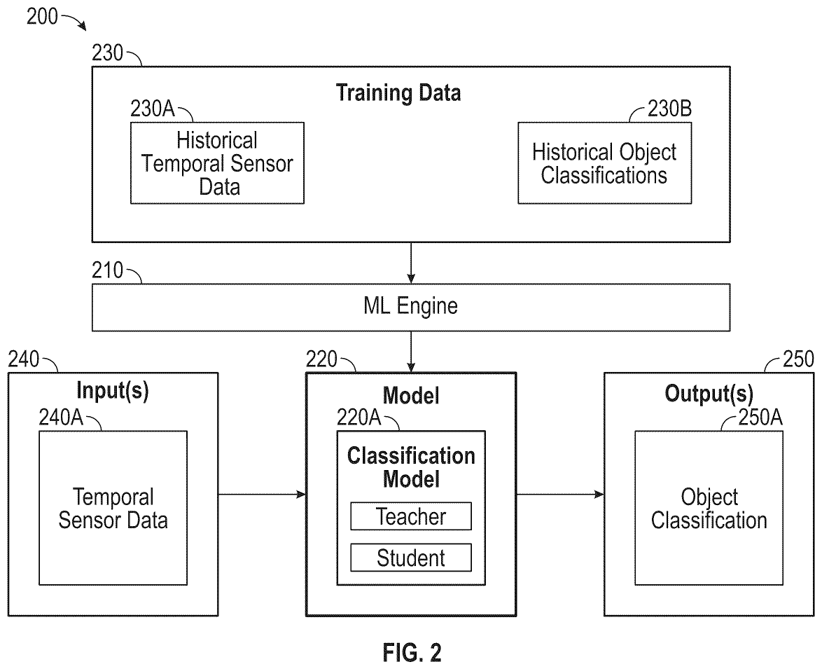

FIG. 2 is a block diagram 200 depicting an example training process of a machine learning model (e.g., the ML model 118), in one implementation of the instant application. Generally, a machine learning (ML) engine 210 (e.g., the ML module 114) trains an ML model 220 using training data 230. The ML engine 210 may train the ML model 220 via regression, k-nearest neighbor, support vector regression, and/or random forest algorithms and/or models, although any type of applicable ML algorithm and/or model may be used. Model training may be performed via one or more of supervised learning, unsupervised learning, semi-supervised learning, and/or reinforcement learning. Once trained, the ML model 220 may perform operations on one or more data inputs 240 to produce a desired data output 250.

In at least some implementations, the ML model 220 may be a classification model 220A (e.g., the teacher model 118A, student model 118B) trained using the training data 230 to classify objects, such as objects indicated in point cloud data and/or images of the environment of the robot 140. The classification may be associated with what the object is and/or any other suitable classification. The trained classification model 220A may receive as the input 240 temporal sensor data 240A that includes point cloud data and image data of the environment, and in response generate as the output 250 a classification of one or more objects 250A (e.g., walls, structures, people, obstacles) of the localized environment indicated in the temporal sensor data.

The classification model 220A may be, or include, a three-dimensional semantic LIDAR inference model having three-dimensional convolutional layers to capture and/or analyze both spatial and temporal contexts of the temporal sensor data 240A. In at least some implementations, the classification model 220A may include a teacher model (e.g., teacher model 118A) and a student model (e.g., student model 118B). The teacher model may perform pseudo-labeling of training data 230 and supervision during training of the student model. The student model may be trained using a knowledge distillation process of the knowledge of the teacher. Compared to the teacher model, the student model may include a simpler architecture (e.g., layer reduction), undergo mixed-precision training, and include runtime optimizations to achieve efficient inference using less powerful and/or fewer computing resources. Accordingly, the student model may be deployed to, and/or implemented by, the robot 140 to perform object classification where the robot 140 would otherwise be unable to implement the teacher model due to computing resource constraints.

The point cloud data of the temporal sensor data 240A may include one or more point clouds that are aggregated over time (temporally-aggregated) as the robot traverses the localized environment. For example, the temporally-aggregated point cloud may initially be generated at first point in time when the robot 140 is initially placed in a first localized environment of the global environment. At a second point in time, the robot 140 may travel through the first localized environment to a second localized environment, capturing point cloud data along the way. As the robot 140 travels, it may aggregate the temporally-aggregated point cloud of the first localized environment generated during the first point in time with additional point cloud information gathered when sensing the second localized environment. The temporally-aggregated point cloud may further include timestamp information indicating when each portion of the point cloud was generated.

The image data of the temporal sensor data 240A may include one or more images captured in synchronicity with the point cloud data as the robot traverses the localized environment. For example, the robot 140 may capture five images of the first localized environment as the robot 140 generates the temporally-aggregated point cloud for the first localized environment, and capture seven images of the second localized environment as the robot 140 generates the portion temporally-aggregated point cloud associated with the second localized environment. The image data may further include timestamp information.

The classification model 220A may perform the classification by applying one or more classifications (e.g., metadata, labels) to the objects based upon semantics indicated in the temporal sensor data. For example, the size, shape, and transparency of an object indicated in the temporal sensor data 240A may cause the model to classify the object as a window.

The ML engine 210 may train the classification model 220A using training data 230. The training data 230 may include historical temporal sensor data 230A of historical environments. The historical temporal sensor data 230A may include historical point cloud data including temporally-aggregated point clouds of the historical environments. The historical temporal sensor data 230A may include historical image data of the historical environments. The historical image data may include images associated with the temporally-aggregated point clouds of the historical environments. The classification model 220A training data 230 may include historical classifications 230B of historical objects indicated in the historical temporal sensor data 230A. The ML engine 210 may be configured to process the training data 230 to learn associations and relationships in the training data 230, e.g., relationships indicating characteristics of historical objects of the historical temporal sensor data 230A indicating what the associated classification of the object is (e.g., what the object is when the classifications are associated with object identification). The engine 210 may train the classification model 220A based upon the learned association and relationship causing the classification model 220A to be able to successfully classify objects 250A based upon receiving temporal sensor data 240A the model has not previously received. In at least some implementations, the historical temporal sensor data 230A may include a mix of simulated (e.g., synthetic) data and large-scale real-world data generated by robots (e.g., on construction sites). The real-world data may be more prevalent in the training data, for example, to improve robustness and generalization of the object classification.

The engine 210 may retrain the ML model 220 using updated training data 230, for example to improve operation of the ML model 220, cause the ML model 220 to have additional functionalities, etc. For example, the robot may receive new temporal sensor data 240A indicating an object that the classification model 220A is unable to classify. The model may be retrained using the new temporal sensor data as updated training data 230, such that the retrained classification model 220A is able to successfully classify the object it was otherwise unable to classify before being retrained.

It should be understood that functionality attributed to a single ML model may be performed by two or more ML models. For example, the classification model 220A may include a first model that analyzes the temporal sensor data 240A such as a point cloud to extract features of the associated terrain, and a second model that receives the extracted features to generate the object classification 250A. Moreover, while model training and execute may be described as performed on the same device (e.g., the system 105), it should be understood that one device may train the model (e.g., the system 105) and another device may execute the trained model (e.g., the robot 140, the computing device 160), such that the ML model 220 may not be trained and executed by the same device.

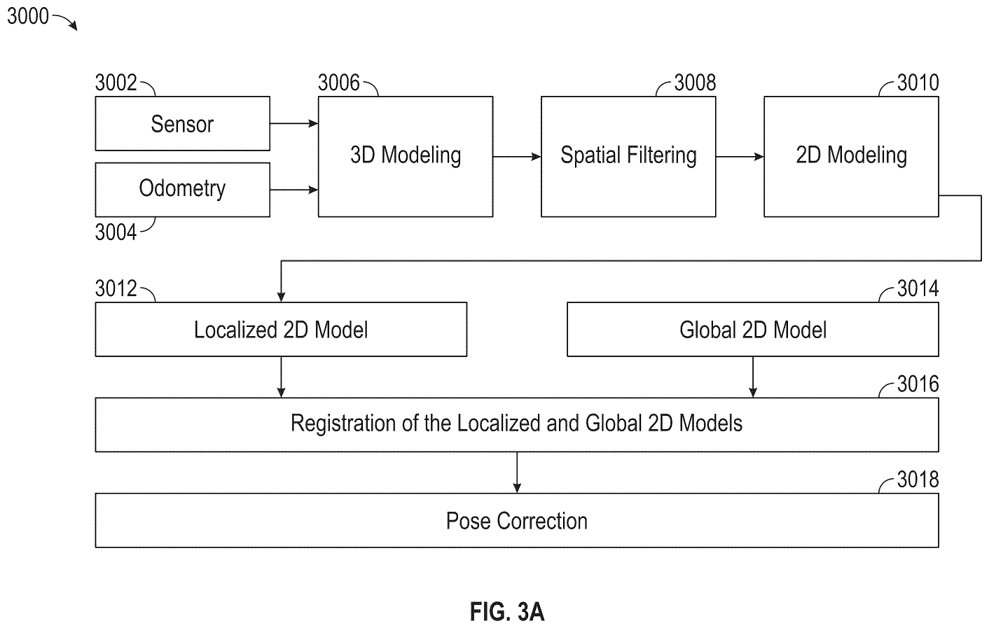

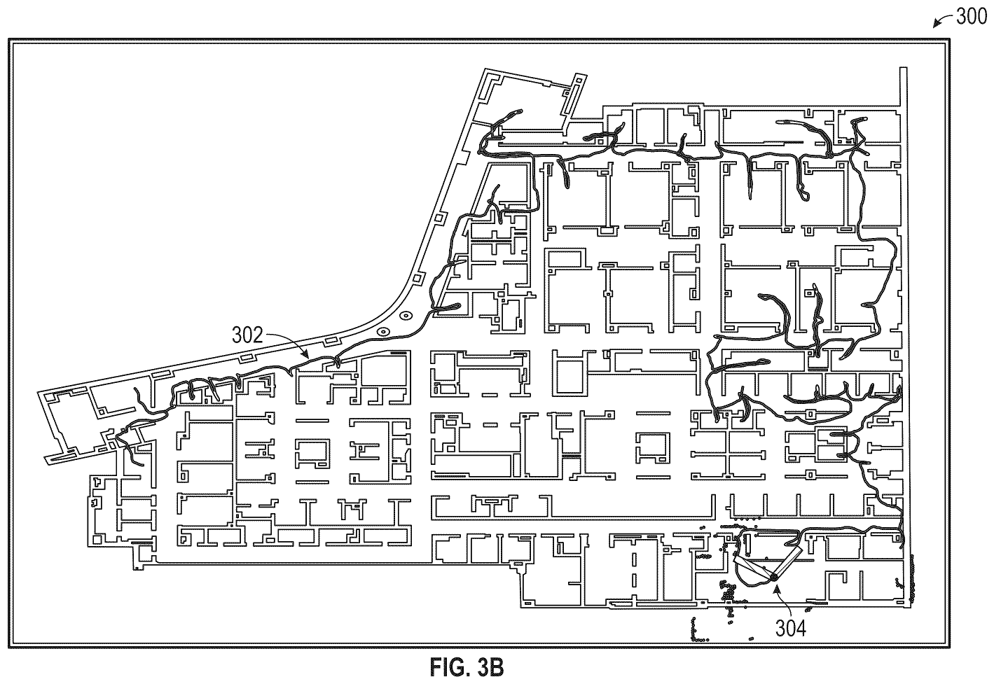

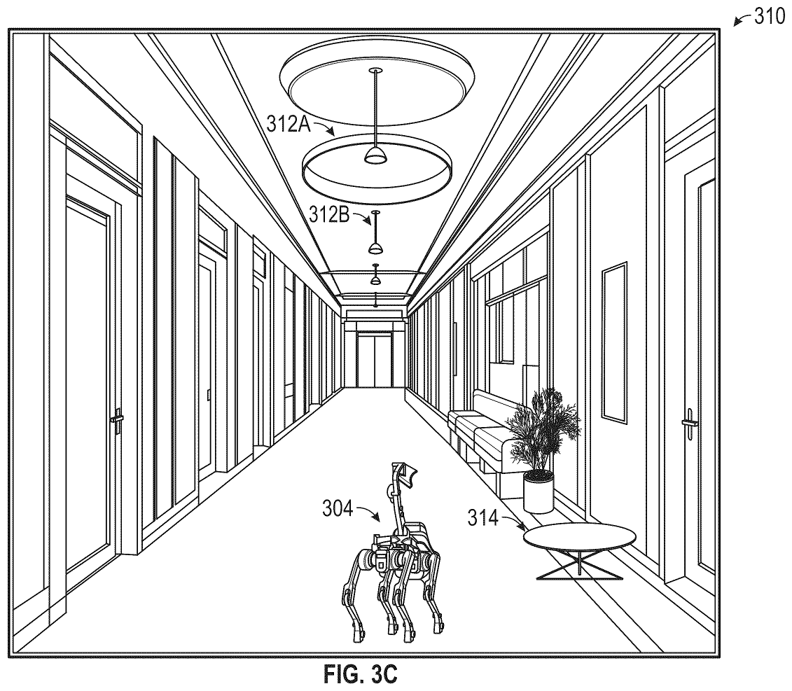

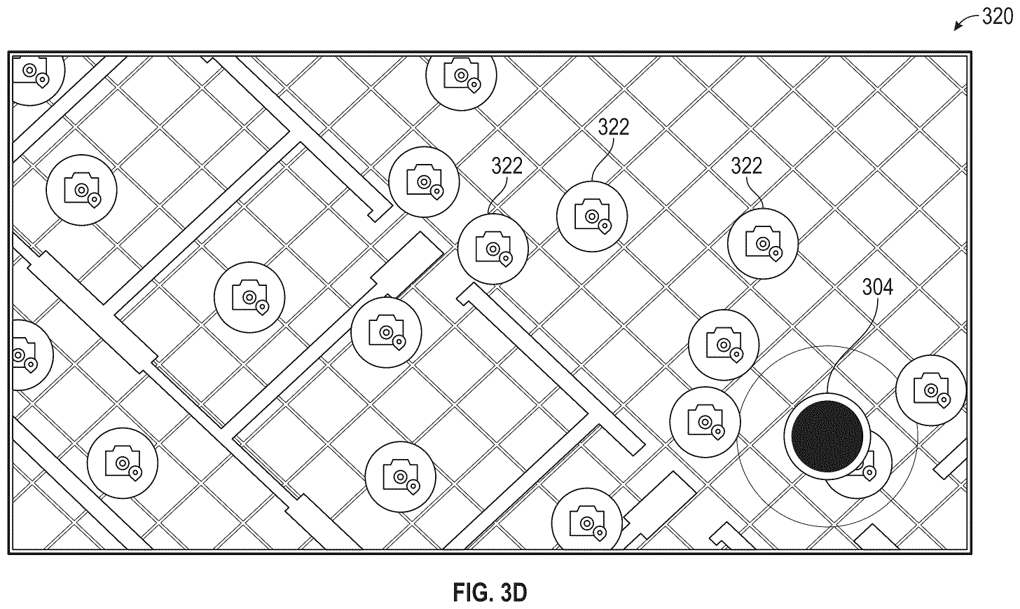

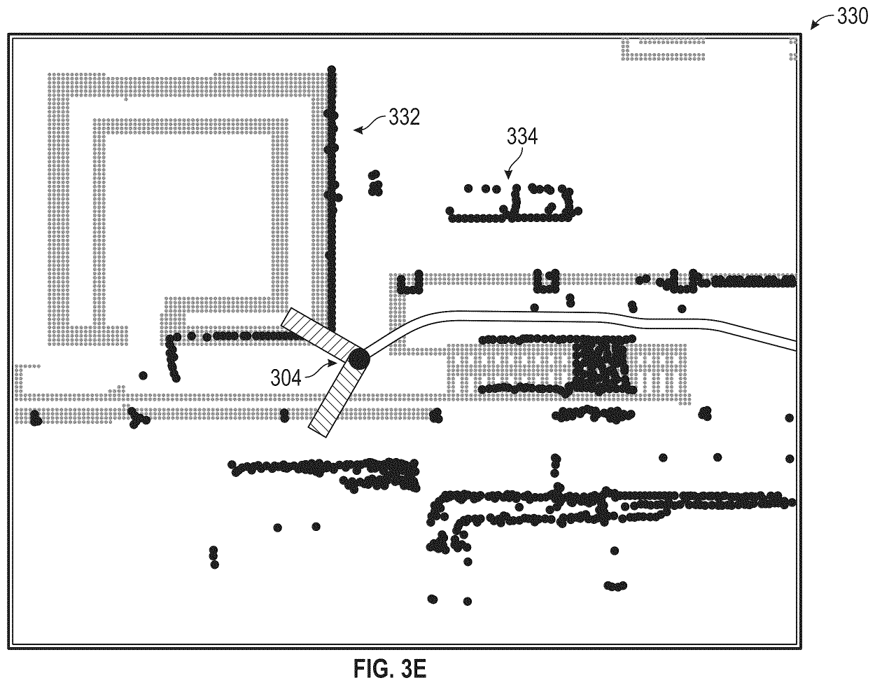

FIG. 3A is a block diagram of an exemplary workflow 3000 for real-time localization and pose correction of a robot, in one implementation of the instant application. One or more steps, functions, processes, etc., of the workflow 3000 may be performed via the computing environment 100 (e.g., the system 105, the robot 140, the computing device 160). The workflow 3000 may include the system 105 obtaining (block 3002) sensor data and obtaining (block 3004) odometry data of the localized environment. Obtaining (blocks 3002, 3004) the sensor data and odometer data may include the robot generating via its sensors 150 the sensor and odometry data, and the data-obtaining subsystem 122 obtaining the senso and oddment data from the robot. The workflow 3000 may include performing (block 3006) three-dimensional modeling (e.g., via the modeling subsystem 124) of the localized environment based upon the sensor data and the odometry data.

FIG. 3B depicts an example global two-dimensional model 300 (e.g., blueprint, a map, or a two-dimensional point cloud) of an example global environment for performing real-time localization and pose correction of a robot, in one implementation of the instant application. The global two-dimensional model 300 depicts a path 302 the robot 304 may traverse while traveling through the global environment. The portions of the global environment the robot 304 may travel through may be considered localized environments of the global environment, as they are local to the robot 304. For example, the robot 304 may travel the path 302 through five hallways and twenty rooms, each of which may be considered localized environments of a larger global environment that includes the entire floor of the building. The robot 304 may generate sensor data of the localized environment including images, video, LIDAR (e.g., point cloud) data, RADAR data, and/or any other suitable sensor data as it traverses the hallways and rooms. The robot 304 may generate odometry data indicating movement of the robot 304 as i traverses the path 302 throughout the localized environments, for example to determine how far the robot 304 travels, its trajectory, speed, etc. Performing (block 3006) three-dimensional modeling of the workflow 3000 may include the robot 304 generating the three-dimensional localized model (e.g., in real-time via the modeling subsystem 124) based upon sensor data and/or the odometry data of the localized environment.

In at least some implementations, the model of the localized environment may be a temporal localized three-dimensional model (e.g., a point cloud, a map) that is continuously updated to only depict portions of the localized environment recently traversed by the robot 304. For example, the robot 304 may first travel through a long hallway that is depicted by a three-dimensional point cloud generated by the robot 304. The robot may then enter a first room and then a second room. As the robot 304 enters the first room, the three-dimensional point cloud may be updated so that the first room is depicted in the three-dimensional point cloud, but only the latter half of the hallway most recently traversed by the robot 304 remains depicted in the three-dimensional point cloud, with the first half of the hallway initially traversed by the robot 304 no longer being depicted in the three-dimensional point cloud. As the robot enters the second room, the three-dimensional point cloud may be updated so that the second room may be depicted in the three-dimensional point cloud as well as the first room, and the hallway may no longer be depicted in the three-dimensional point cloud. The robot 304 may generate the odometer data and the sensor data including LIDAR scans as the robot 304 travels through the hallway and first and second rooms. The sensor data and the odometry data may include timestamp information, allowing the robot 304 to model its localized environment in a temporal manner such that only recently traversed localized environments are depicted in a temporal localized three-dimensional model.

Generating the temporal localized three-dimensional model may be based upon temporal model generation criteria. The temporal model generation criteria may be associated with a size of the temporal localized three-dimensional model (e.g., the temporal localized three-dimensional model is generated to not exceed a particular size), compute resources of the robot 304 (e.g., the level of detail depicted by the model based upon processing resources, sensor characteristics, power available, etc.), temporal characteristics (e.g., only modeling environment encountered with the last five minutes), and/or any other suitable characteristics. By modeling the localized environment using via the temporal localized three-dimensional model based upon temporal model generation criteria, the robot 304 may generate a model that is able to be processed (e. generated, analyzed, stored) with fewer and/or less powerful computer resources while still serving its intended purposes (e.g., localization, registration, etc.). Advantageously, the temporal localized three-dimensional model may be processed on-board the robot 304 which may have less powerful computer resources than at a server (e.g., the system 105) or otherwise computing device (e.g., the computing device 160). This may allow the robot 140 to operate autonomously in environments where communication with other devices may be limited or unavailable.

FIG. 3C depicts an example localized environment 310 for generating an example localized three-dimensional model, in one implementation of the instant application. The localized environment 310 may include a hallway of a building (e.g., global environment) depicted in the global two-dimensional model 300. The robot 304 may scan the room using LIDAR sensors (e.g., the sensors 150) to generate sensor data including a three-dimensional point cloud of the localized environment 310. The robot 304 may also generate the odometry data as it moves throughout the localized environment 310 (e.g., to interpret distance between objects encountered while traversing the hallway, the orientation of the robot 304 when scanning the objects, etc.), which along with the three-dimensional point cloud, may also be used by the robot 304 to generate a localized three-dimensional model of the hallway and objects therein.

Returning to FIG. 3A, the workflow 3000 may include performing (block 3008) spatial filtering that causes portions of the localized environment indicated in the sensor data (e.g. hallways and objects therein) to not be depicted in localized three-dimensional model generated during the three-dimensional modeling. Accordingly, performing the spatial filtering may include altering the localized three-dimensional model generated during the workflow 3000. Performing (block 3008) spatial filtering may include performing height filtering that causes a first portion of the localized environment located above a maximum vertical distance respective to the robot 304 to not be depicted in the localized three-dimensional model and/or a second portion of the localized environment located below a minimum vertical distance respective to the robot 304 to not be depicted in the localized three-dimensional model. For example the ceiling lamps 312A, 312B may be above the maximum vertical distance respective to the robot 304 and the coffee table 314 may be below the minimum vertical distance respective to the robot 304. Accordingly, the ceiling lamps 312A, 312B and the coffee table 314 may not be depicted in the localized three-dimensional model of the hallway based upon performing (block 3008) the spatial filtering. It should be understood that although the spatial filtering is described in terms of vertical distance thresholds (e.g. maximum and minimum vertical distance), the spatial filtering may be associated with filtering any spatial aspect of the localized environment. For example, objects beyond a distance in front, behind, and/or to the sides of the robot 304 may be filtered out of the localized three-dimensional model, and/or any other suitable spatial filtering.

In at least some implementations, the robot 304 may generate the localized three-dimensional model using machine learning to only include objects having particular classifications. In some such implementations, generating the localized three-dimensional model may include obtaining temporal sensor data of the localized environment including point cloud data and image data. The point cloud data may include a temporally-aggregated point cloud generated as the robot traverses the localized environment. The image data may include one or more images captured in synchronicity with the point cloud data as the robot traverses the localized environment.

FIG. 3D depicts an example model 320 of an example localized environment for generating a localized three-dimensional model using machine learning, in one implementation of the instant application. The robot 304 may traverse the localized environment depicted by the model 320, collecting temporal sensor data as it travels including timestamped including point cloud to generate a temporally-aggregated point cloud of each of the rooms and hallway of the depicted localized environment. For example, point cloud generated depicting the hallway in which the robot 304 is located in FIG. 3D may be aggregated with additional point cloud when the robot then enters a room. The camera icons 322 may each indicate where the robot 304 captures timestamped images of the localized environment that correspond to the temporally-aggregated point cloud, such as capturing pictures of the hallway when generating the temporally-aggregated point cloud associated with the hallway, capturing images of the rooms when generating the temporally-aggregated point cloud depicting the rooms, etc. The robot 304 may provide the temporal sensor data to a model (e.g., the ML model 118, 220) causing the model to classify objects indicated in the temporal sensor data (e.g., the point cloud, the images). In at least some implementations, the model may be a student classifier model (e.g., the student model 118B) that is less compute resource-intensive than its teacher classifier model (e.g., the teacher model 118A), for example due to the architecture of the student model or the more limited classification capabilities of the student mode as compared to the teacher model. This may allow implementation of the student model on the robot 304 (e.g., to perform object classification based upon receiving sensor data) that may have limited compute resources.

The objects may be classified based upon semantics of the objects indicated in the temporal sensor data, such as their size, shape, relationship to one another, etc. For example, the model may classify objects as structures, (e.g., walls, columns), people, plants, etc. Classifying the objects may include applying one or more classifications to each object, such as classifications elected from a predefined taxonomy. In response to classifying the objects, the robot 304 may generate the localized three-dimensional model of the localized environment that is based on at least a portion of the temporally-aggregated point cloud corresponding to objects having particular classification(s). For example, the robot 304 may generate the localized three-dimensional model to only include structural elements and not any people or plants. As the localized three-dimensional model may be used for localization and/or registration, for example, particular objects may be more relevant for these purposes than others. For example, walls and columns of a building may be represented in a BIM of the global environment, whereas people and plants would not. Accordingly, generating the localized three-dimensional model to only include structure elements may provide a better reference for comparing the BIM to the localized three-dimensional model when determining the pose of the robot 304 or performing registration of the BIM and the localized three-dimensional model. Accordingly, the localized three-dimensional model generated to have only particular objects may be a better reference than the localized three-dimensional model including everything sensed in the localized environment. In at least some implementations where a machine learning model is used to perform (block 3008) the three-dimensional modeling temporal model generation, performing (block 3008) the spatial filtering may not be necessary, for example when the model eliminates objects that would otherwise need to be removed using spatial filtering.

The localized three-dimensional model that is spatially filtered and/or only includes particularly classified object may be able to be processed (e. generated, analyzed, stored) with fewer and/or less powerful computer resources than had the model not been spatially filtered or restricted to depicting particularly classified objects while still serving its intended purposes (e.g., localization, registration, etc.). Advantageously, the such a localized three-dimensional model may be processed on-board the robot 304, which may have less powerful compute resources than at a server (e.g., the system 105) or otherwise computing device (e.g., the computing device 160). As just illustrated, there may be instances where performing (block 3008) the spatial filtering or object classification may serve the same purpose in generating models which may be processed with fewer compute resources and/or more efficiently than full-featured models, and thus models generated using spatial filtering techniques or object classification techniques may in the end serve the same purpose, and thus the techniques may be used interchangeably depending on the scenario.

The workflow 3000 may include the robot 304 performing two-dimensional modeling 3010 of the localized three-dimensional model to generate a localized two-dimensional model 3012 (e.g., two-dimensional point cloud, map) of the localized environment. The localized two-dimensional model 3012 may depict the localized environment from an aerial perspective (e.g., bird's eye view). The localized two-dimensional model 3012 may be based upon transforming the localized three-dimensional model generated at blocks 3006 and/or 3008 of the workflow 3000. In at least some implementations, generating the localized two-dimensional model 3012 may include transforming a three-dimensional point cloud (e.g., the localized three-dimensional model) to a gravity-defined frame associated with a gravity vector (e.g., to compensate for the orientation or otherwise pose of the robot, such as being located on a slanted ground surface). The transformation may include rotating and translating the three-dimensional point cloud (e.g., one or more point of the three-dimensional point cloud) in accordance with the gravity-defined frame. A planar projection of the transformed three-dimensional point-cloud onto a two-dimensional plane may generate a two-dimensional point cloud (e.g., the localized two-dimensional model 3012).

The workflow 3000 may include obtaining (block 3014) a global two-dimensional model of the global environment, such as the example global two-dimensional model 300 of FIG. 3B. The global two-dimensional model may be included in environmental data associated with a global environment in which the robot 304 operates. The global two-dimensional model may be a blueprint, a map, or a two-dimensional point cloud. The global two-dimensional model may depict the global environment from an aerial, top-down, bird's eye view (BEV) perspective. The global two-dimensional model may be used as a reference. For example, a user of the computing device 160 may view the global two-dimensional model and the localized three-dimensional model to estimate where the robot 304 may be located within the global environment based upon comparing the global two-dimensional model with the localized model (e.g., the localized two-dimensional and/or three-dimensional models generated during the workflow 3000) of the localized environment.

It should be understood that the disclosed techniques may be used to generate models other than localized models. For example, a model (e.g., blueprint, map, BIM) of the global environment may not exist, or existing global models may be inadequate. To obtain (block 3014) the global two-dimensional model, the robot 304 may traverse the entire global environment while generating sensor data (e.g., point cloud, images) and odometry data, and generate a global model of the global environment. This may include performing spatial filtering and/or object classification to the global model, for example generate a BIM that only includes structural objects based upon the spatial filtering and/or object classification. The robot 304 may generate various types of global models, such as a three-dimensional global model (e.g., based upon global three-dimensional point cloud(s)) and/or a two-dimensional global model (e.g., a global two-dimensional point cloud generated by transforming a global three-dimensional point cloud).

During the workflow 3000, an estimated pose (e.g., location, position, orientation, etc.) of the robot 304 in the localized environment depicted by the localized two-dimensional model 3012 may be obtained. In one example, a computing device (e.g., the system 105, the computing device 160) may receive (e.g., from the system 105, the data-obtaining subsystem 122, the robot 304) the localized two-dimensional model 3012 and the global two-dimensional model. The localized and global two-dimensional models may be output at a display (e.g., the user interface 168) of the computing device. A user may compare the localized two-dimensional model 3012 and the global two-dimensional model to determine an estimated pose of the robot 304, for example based upon matching structures indicated in the localized two-dimensional model 3012 with similar structures indicated in the global two-dimensional model. The user may cause the computing device to transmit information indicating the estimate pose from the computing (e.g., via the network 110) to the robot 304. In another example, the computing device and/or the robot 304 may determine the estimated pose, for example using models, algorithms, matching techniques, subsystems (e.g., the pose subsystem 128), the localized and global two-dimensional models, robot configuration data indicating the initial pose, and/or other suitable data (e.g., odometry data, sensor data, etc.). However, the disclosed techniques may include any other suitable manner of estimating the pose of the robot 304 in the localized environment.

The workflow 3000 may include the system 105 and/or robot 304 performing (block 3016) a registration (e.g., via the localization subsystem 126) of the localized two-dimensional model 3012 with the global two-dimensional model based upon the estimated pose of the robot 304. For example, the obtained estimated pose of the robot 304 may indicate a portion (e.g., the portion where the robot 304 is estimated to be located) of the localized two-dimensional model 3012 and/or the corresponding portion of the global two-dimensional model to compare when performing the registration. The registration of the localized and global two-dimensional models may be performed via any suitable registration techniques, such as an iterative closets point (ICP) algorithm applied to two-dimensional point clouds representing the localized two-dimensional model 3012 and the global two-dimensional model. For example, the registration techniques may include matching and/or aligning objects (e.g., structures such as walls, pillars, columns, etc.) in the localized and global two-dimensional models to understand how they correspond with one another. By using two-dimensional models for registration, the less powerful compute resources (e.g., resources of the robot 304) may perform the registration than if using three-dimensional point clouds for registration, without sacrificing accuracy. Performing (block 3016) the registration may generate a transformation function associated with aligning the localized two-dimensional model 3012 and the global two-dimensional model (e.g., to a common coordinate system).

FIG. 3E depicts an example composite two-dimensional model 330 for performing an example registration, in one implementation of the instant application. The composite two-dimensional model 330 may include the global two-dimensional model overlaid with the localized two-dimensional model 3012. A registration may be performed based upon matching objects (e.g., representing environmental structural elements) indicated the global two-dimensional model with corresponding objects sensed in the localized environment as depicted in localized two-dimensional model 3012. For example, object 332 may correspond to a wall and object 334 may correspond to pillars that are indicated and matched between the global two-dimensional model and the localized two-dimensional model 3012 of the composite two-dimensional model 330.

Performing the registration may include calculating a registration confidence metric indicating a confidence of the registration of the localized two-dimensional model 3012 with the global two-dimensional model. For example, the registration confidence metric may be based upon how many points of the localized two-dimensional point cloud of the localized two-dimensional model 3012 can be successfully matched with corresponding points of the global two-dimensional point cloud of the global three-dimensional model. The more point cloud points that are successfully matched may indicate a higher confidence in the registration between the local and global two-dimensional models.

The workflow 3000 may include performing (block 3018) a pose correction of the robot 304. Performing (block 3018) the pose correction may include generating (e.g., via the pose subsystem 128) corrected pose data indicating a corrected pose of the robot 304 in the localized environment based upon the transformation function. For example, the transformation function may indicate how to align the localized two-dimensional model 3012 with the global two-dimensional model, and in doing so provide an indication of the actual pose of the robot, for example the actual pose of the robot 304 when it generated at least a portion of the localized model (e.g., the localized two-dimensional model 3012 or the localized three-dimensional model from which the localized two-dimensional model 3012 is derived) used in registration. The actual pose may differ from the estimated pose (e.g., due to odometry drift, etc.), such that the pose of the robot 304 should be corrected respective to the inaccurate estimated pose. Accordingly, the robot 304 may be configured (e.g., via the pose subsystem 128) using the corrected pose data, causing the robot 304 to determine a corrected pose (e. location, position, orientation, etc.) of the robot 304 within the global environment. Based upon the understanding its corrected pose, the robot 304 may be able to successfully perform one or more tasks (e.g., autonomously) in the global environment and/or otherwise successfully navigate the global environment. In at least some implementations, based upon the registration confidence metric of the registration process not exceeding a registration confidence metric threshold, the robot 304 may refrain from configuring itself using the corrected pose data, for example because the registration confidence metric indicated the registration has a low confidence and may not be entirely accurate.

It should be understood that scenarios, examples, etc., described in the aforementioned examples of FIGS. 3B-3E are for illustration purposes. Accordingly, functionalities attributed to one device, such as the system 105 or the robot 304, may be performed via any suitably configured component(s) of other device(s), such as the system 105, the robot 304, and/or computing device 160. In one example, a user of computing device 160 may remotely configure the robot to correct the pose rather than the robot 304 configuring itself. In another example, the system 105 may generate one or more models and/or perform object classification (e.g., via the teacher model 118A) rather than being performed on the robot 304.

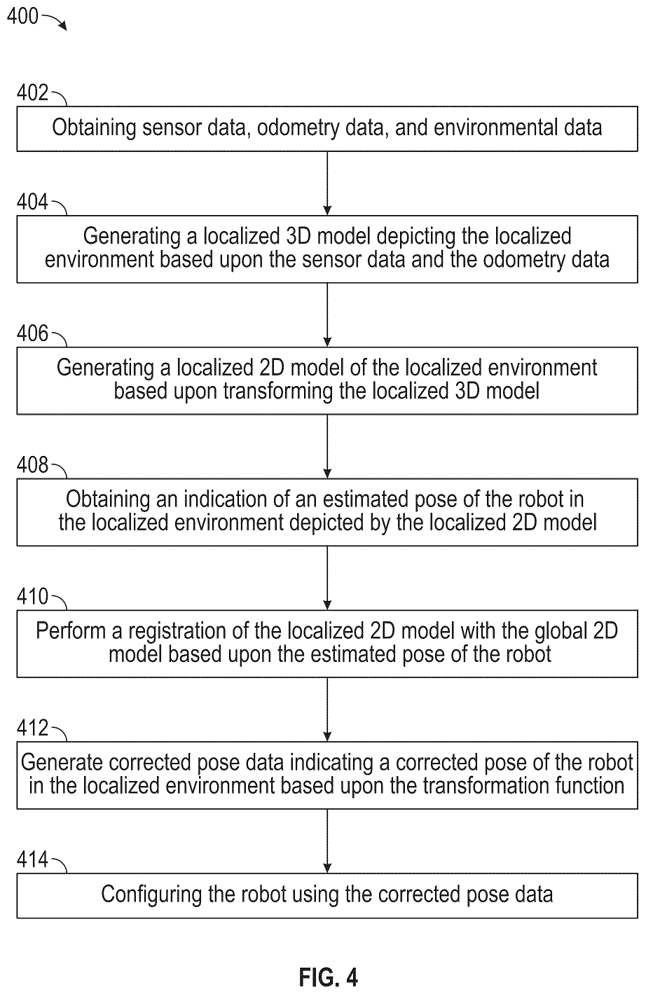

FIG. 4 is a flow diagram depicting an example computer-implemented method 400 for real-time localization and pose correction of a robot, in one implementation of the instant application. One or more steps of the computer-implemented method 400 may be implemented as a set of instructions stored on a computer-readable memory and executable via one or more local or remote processors (e.g., the processor 102, 142, 162), computing devices (e.g., the system 105, the robot 140, the computing device 160), and/or other electronic or electrical components, which may be in wired or wireless communication with one another.

The computer-implemented method 400 may include obtaining sensor data, odometry data, and environmental data (block 402). The sensor data may indicate one or more characteristics of a localized environment that is at least a portion of a global environment. The localized environment may be localized respective to the robot (e.g., the robot 140) as it generates the sensor data while traversing the localized environment. The odometry data may indicate movement of the robot while traversing the localized environment. The environmental data may include a global two-dimensional model that depicts the global environment from an aerial perspective (e.g. a bird's-eye view).

The computer-implemented method 400 may include generating a localized three-dimensional model depicting the localized environment based upon the sensor data and the odometry data (block 404).

In at least some implementations of the exemplary computer-implemented method 400, the localized three-dimensional model may be a temporal localized three-dimensional model that is continuously updated to only depict portions of the localized environment recently traversed by the robot. The temporal localized three-dimensional model may be generated based upon temporal model generation criteria (e.g., computing resources of the model, model size, etc.).

In at least some implementations, generating the localized three-dimensional model (block 404) may include perform spatial filtering of the localized three-dimensional model causing portions of the localized environment indicated in the sensor data to not be depicted in localized three-dimensional model. The portions of the localized environment not depicted based upon the spatial filtering may include a first portion of the localized environment located above a maximum vertical distance (e.g., ten feet) respective to the robot, and a second portion of the localized environment located below a minimum vertical distance (e.g., one foot) respective to the robot.

The computer-implemented method 400 may include generating a localized two-dimensional model (e.g., the localized two-dimensional model 3012) of the localized environment that depicts the localized environment from the aerial perspective based upon transforming the localized three-dimensional model (block 406).

In at least some implementations of the computer-implemented method 400, generating the localized two-dimensional model (block 406) may include transforming a three-dimensional point cloud of the localized three-dimensional model to a gravity-defined frame associated with a gravity vector via rotation and translation of the three-dimensional point cloud; and performing a planar projection of the transformed three-dimensional point-cloud onto a two-dimensional plane to generate a two-dimensional point cloud of the localized two-dimensional model.

In at least some implementations of the computer-implemented method 400, the environmental data may include a building information model (BIM) of the global environment, and the computer-implemented method 400 may include generating the global two-dimensional model (block 406) having a two-dimensional point cloud of the global environment based upon the BIM. In some such implementations, the computer-implemented method 400 may include causing the robot to generate the sensor data and the odometry data while traversing the global environment; and generating the BIM based upon the sensor data and the odometry data.

The computer-implemented method 400 may include obtaining an indication of an estimated pose of the robot in the localized environment depicted by the localized two-dimensional model (block 408). In at least some implementations, obtaining the indication of the estimated pose (block 408) may include transmitting, to a user device (e.g., the computing device 160), the localized two-dimensional model and the global two-dimensional model; and in response to transmitting the localized two-dimensional model and the global two-dimensional model to the user device, receive, from the user device, the indication of the estimated pose of the robot.

The computer-implemented method 400 may include performing a registration of the localized two-dimensional model with the global two-dimensional model based upon the estimated pose of the robot (block 410). The registration may generate a transformation function associated with aligning the localized two-dimensional model and the global two-dimensional model. Performing the registration of the localized two-dimensional model with the global two-dimensional model (block 410) may include applying an iterative closest point (ICP) algorithm to the localized two-dimensional model and the global two-dimensional model (e.g., to identify corresponding objects, such as structures of the environment, between the localized and global two-dimensional models).

The computer-implemented method 400 may include generating corrected pose data indicating a corrected pose of the robot in the localized environment based upon the transformation function (block 412).

The computer-implemented method 400 may include configuring the robot using the corrected pose data (block 414) to identify the corrected pose of the robot within the global environment that differs from the estimated pose. Identifying the corrected pose of the robot may include identifying one or more of: a location of the robot within the global environment; an orientation of the robot within the global environment; or odometry drift.

In at least some implementations, the computer-implemented method 400 may include calculating a registration confidence metric indicating a confidence of the registration of the localized two-dimensional model with the global two-dimensional model; and based upon the registration confidence metric not exceeding a registration confidence metric threshold, refrain from configuring the robot using the corrected pose data.

In at least some implementations, the computer-implemented method 400 may include obtaining temporal sensor data temporal sensor data of the localized environment including: point cloud data including a temporally-aggregated point cloud generated as the robot traverses the localized environment, and image data including one or more images captured in synchronicity with the point cloud data as the robot traverses the localized environment; provide the temporal sensor data to a model (e.g., the ML model 118, 220) causing the model to classify objects indicated in the temporal sensor data based upon semantics of the objects indicated in the temporal sensor data; and in response to classifying the objects, generate the localized three-dimensional model of the localized environment based at least upon a portion of the temporally-aggregated point cloud corresponding to objects of the localized environment having at least one particular classification of the one or more classifications. Classifying the objects may include applying one or more classifications to each object. In some such implementations, the computer-implemented method 400 may include obtaining model training data (e.g., the training data 230) including: historical temporal sensor data (e.g., historical temporal sensor data 230A) including historical point cloud data including temporally-aggregated point clouds of historical environments and historical image data of the historical environments including images associated with the temporally-aggregated point clouds of the historical environments, and historical classifications of historical objects (e.g., historical classifications 230B) indicated in the historical temporal sensor data; training a teacher model (e.g., the teacher model 118A) using the model training data to perform classifications of objects indicated in the historical environments; and training a student model (e.g., the student model 118B) using knowledge distillation of knowledge of the teacher model causing the student model to perform at least some of the classifications performed by the teacher model such as classifying the objects indicated in the temporal sensor data.

It should be understood that not all blocks of the exemplary flow diagram of FIG. 4 are required to be performed.

While various embodiments and/or implementations have been described, the description is intended to be exemplary, rather than limiting, and it is understood that many more embodiments and/or implementations are possible that are within the scope of the embodiments and/or implementations. Although many possible combinations of features are shown in the accompanying figures and discussed in this detailed description, many other combinations of the disclosed features are possible. Any feature of any embodiment and/or implementation may be used in combination with or substituted for any other feature or element in any other embodiment and/or implementation unless specifically restricted. Therefore, it will be understood that any of the features shown and/or discussed in the present disclosure may be implemented together in any suitable combination. Accordingly, the embodiments and/or implementations are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A system for real-time localization and pose correction of a robot, the system comprising:
one or more processors; and
one or more memories having stored thereon processor-executable instructions that, when executed by the one or more processors, cause the one or more processors to:
obtain (i) sensor data indicating one or more characteristics of a localized environment, (ii) odometry data indicating movement of the robot while traversing the localized environment, and (iii) environmental data including a global two-dimensional model that depicts a global environment from an aerial perspective, wherein:
the localized environment is at least a portion of the global environment, and
the localized environment is localized respective to the robot as it generates the sensor data while traversing the localized environment;
generate a localized three-dimensional model depicting the localized environment based upon the sensor data and the odometry data;
generate a localized two-dimensional model of the localized environment that depicts the localized environment from the aerial perspective based upon transforming the localized three-dimensional model;
obtain an indication of an estimated pose of the robot in the localized environment depicted by the localized two-dimensional model;
perform a registration of the localized two-dimensional model with the global two-dimensional model based upon the estimated pose of the robot, wherein the registration generates a transformation function associated with aligning the localized two-dimensional model and the global two-dimensional model;
generate corrected pose data indicating a corrected pose of the robot in the localized environment based upon the transformation function; and
configure the robot using the corrected pose data to identify the corrected pose of the robot within the global environment that differs from the estimated pose.

2. The system of claim 1, wherein:
the localized three-dimensional model is a temporal localized three-dimensional model that is continuously updated to only depict portions of the localized environment recently traversed by the robot; and
the temporal localized three-dimensional model is generated based upon temporal model generation criteria.

3. The system of claim 1, wherein to generate the localized three-dimensional model, the one or more memories further comprise instructions that, when executed by the one or more processors, cause the one or more processors to perform spatial filtering of the localized three-dimensional model causing portions of the localized environment indicated in the sensor data to not be depicted in localized three-dimensional model, wherein the portions of the localized environment not depicted based upon the spatial filtering include:
a first portion of the localized environment located above a maximum vertical distance respective to the robot, and
a second portion of the localized environment located below a minimum vertical distance respective to the robot.

4. The system of claim 1, the one or more memories further comprising instructions that, when executed by the one or more processors, cause the one or more processors to:
obtain temporal sensor data of the localized environment including:
point cloud data including a temporally-aggregated point cloud generated as the robot traverses the localized environment; and
image data including one or more images captured in synchronicity with the point cloud data as the robot traverses the localized environment;
provide the temporal sensor data to a model causing the model to classify objects indicated in the temporal sensor data based upon semantics of the objects indicated in the temporal sensor data, wherein classifying the objects includes applying one or more classifications to each object; and
in response to classifying the objects, generate the localized three-dimensional model of the localized environment based at least upon a portion of the temporally-aggregated point cloud corresponding to objects of the localized environment having at least one particular classification of the one or more classifications.

5. The system of claim 4, the one or more memories further comprising instructions that, when executed by the one or more processors, cause the one or more processors to:
obtain model training data including:
historical temporal sensor data including historical point cloud data including temporally-aggregated point clouds of historical environments, and historical image data of the historical environments including images associated with the temporally-aggregated point clouds of the historical environments; and
historical classifications of historical objects indicated in the historical temporal sensor data;
train a teacher model using the model training data to perform classifications of objects indicated in the historical environments; and
train a student model using knowledge distillation of knowledge of the teacher model causing the student model to perform at least some of the classifications performed by the teacher model including classifying the objects indicated in the temporal sensor data.

6. The system of claim 1, wherein to generate the localized two-dimensional model, the one or more memories further comprise instructions that, when executed by the one or more processors, cause the one or more processors to:
transform a three-dimensional point cloud of the localized three-dimensional model to a gravity-defined frame associated with a gravity vector via rotation and translation of the three-dimensional point cloud; and
perform a planar projection of the transformed three-dimensional point-cloud onto a two-dimensional plane to generate a two-dimensional point cloud of the localized two-dimensional model.

7. The system of claim 1, wherein:
the environmental data includes a building information model (BIM) of the global environment, and
the one or more memories further comprise instructions that, when executed by the one or more processors, cause the one or more processors to generate the global two-dimensional model having a two-dimensional point cloud of the global environment based upon the BIM.

8. The system of claim 7, the one or more memories further comprising instructions that, when executed by the one or more processors, cause the one or more processors to:
cause the robot to generate the sensor data and the odometry data while traversing the global environment; and
generate the BIM based upon the sensor data and the odometry data.

9. The system of claim 1, wherein to obtain the indication of the estimated pose of the robot, the one or more memories further comprise instructions that, when executed by the one or more processors, cause the one or more processors to:
transmit, to a user device, the localized two-dimensional model and the global two-dimensional model; and
in response to transmitting the localized two-dimensional model and the global two-dimensional model to the user device, receive, from the user device, the indication of the estimated pose of the robot.

10. The system of claim 1, the one or more memories further comprising instructions that, when executed by the one or more processors, cause the one or more processors to:
calculate a registration confidence metric indicating a confidence of the registration of the localized two-dimensional model with the global two-dimensional model; and
based upon the registration confidence metric not exceeding a registration confidence metric threshold, refrain from configuring the robot using the corrected pose data.

11. The system of claim 1, wherein to perform the registration of the localized two-dimensional model with the global two-dimensional model, the one or more memories further comprise instructions that, when executed by the one or more processors, cause the one or more processors to apply an iterative closest point algorithm to the localized two-dimensional model and the global two-dimensional model.

12. A computer-implemented method for real-time localization and pose correction of a robot, the computer-implemented method comprising:
obtaining, by one or more processors, (i) sensor data indicating one or more characteristics of a localized environment, (ii) odometry data indicating movement of the robot while traversing the localized environment, and (iii) environmental data including a global two-dimensional model that depicts a global environment from an aerial perspective, wherein:
the localized environment is at least a portion of the global environment, and
the localized environment is localized respective to the robot as it generates the sensor data while traversing the localized environment;
generating, by the one or more processors, a localized three-dimensional model depicting the localized environment based upon the sensor data and the odometry data;
generating, by the one or more processors, a localized two-dimensional model of the localized environment that depicts the localized environment from the aerial perspective based upon transforming the localized three-dimensional model;
obtaining, by the one or more processors, an indication of an estimated pose of the robot in the localized environment depicted by the localized two-dimensional model;
performing, by the one or more processors, a registration of the localized two-dimensional model with the global two-dimensional model based upon the estimated pose of the robot, wherein the registration generates a transformation function associated with aligning the localized two-dimensional model and the global two-dimensional model;
generating, by the one or more processors, corrected pose data indicating a corrected pose of the robot in the localized environment based upon the transformation function; and
configuring, by the one or more processors, the robot using the corrected pose data to identify the corrected pose of the robot within the global environment that differs from the estimated pose.

13. The computer-implemented method of claim 12, wherein:
the localized three-dimensional model is a temporal localized three-dimensional model that is continuously updated to only depict portions of the localized environment recently traversed by the robot; and
the temporal localized three-dimensional model is generated based upon temporal model generation criteria.

14. The computer-implemented method of claim 12, wherein generating the localized three-dimensional model further comprises performing, by the one or more processors, spatial filtering of the localized three-dimensional model causing portions of the localized environment indicated in the sensor data to not be depicted in localized three-dimensional model, wherein the portions of the localized environment not depicted based upon the spatial filtering include:
a first portion of the localized environment located above a maximum vertical distance respective to the robot, and
a second portion of the localized environment located below a minimum vertical distance respective to the robot.

15. The computer-implemented method of claim 12, further comprising:
obtaining, by the one or more processors, temporal sensor data of the localized environment including:
point cloud data including a temporally-aggregated point cloud generated as the robot traverses the localized environment; and
image data including one or more images captured in synchronicity with the point cloud data as the robot traverses the localized environment;
providing, by the one or more processors, the temporal sensor data to a model causing the model to classify objects indicated in the temporal sensor data based upon semantics of the objects indicated in the temporal sensor data, wherein classifying the objects includes applying one or more classifications to each object; and
in response to classifying the objects, generating, by the one or more processors, the localized three-dimensional model of the localized environment based at least upon a portion of the temporally-aggregated point cloud corresponding to objects of the localized environment having at least one particular classification of the one or more classifications.

16. The computer-implemented method of claim 15, further comprising:
obtaining, by the one or more processors, model training data including:
historical temporal sensor data including historical point cloud data including temporally-aggregated point clouds of historical environments, and historical image data of the historical environments including images associated with the temporally-aggregated point clouds of the historical environments; and
historical classifications of historical objects indicated in the historical temporal sensor data;
training, by the one or more processors, a teacher model using the model training data to perform classifications of objects indicated in the historical environments; and
training, by the one or more processors, a student model using knowledge distillation of knowledge of the teacher model causing the student model to perform at least some of the classifications performed by the teacher model including classifying the objects indicated in the temporal sensor data.

17. The computer-implemented method of claim 12, wherein generating the localized two-dimensional model further comprises:
transforming, by the one or more processors, a three-dimensional point cloud of the localized three-dimensional model to a gravity-defined frame associated with a gravity vector via rotation and translation of the three-dimensional point cloud; and
performing, by the one or more processors, a planar projection of the transformed three-dimensional point-cloud onto a two-dimensional plane to generate a two-dimensional point cloud of the localized two-dimensional model.

18. The computer-implemented method of claim 12, further comprising:
causing, by the one or more processors, the robot to generate the sensor data and the odometry data while traversing the global environment;
generating, by the one or more processors, a building information model (BIM) of the global environment based upon the sensor data and the odometry data; and
generating, by the one or more processors, the global two-dimensional model having a two-dimensional point cloud of the global environment based upon the BIM.

19. The computer-implemented method of claim 12, further comprising:
calculating, by the one or more processors, a registration confidence metric indicating a confidence of the registration of the localized two-dimensional model with the global two-dimensional model; and
based upon the registration confidence metric not exceeding a registration confidence metric threshold, refraining, by the one or more processors, from configuring the robot using the corrected pose data.

20. A non-transitory computer-readable medium storing processor-executable instructions that, when executed by one or more processors, may cause the one or more processors to:
obtain (i) sensor data indicating one or more characteristics of a localized environment, (ii) odometry data indicating movement of a robot while traversing the localized environment, and (iii) environmental data including a global two-dimensional model that depicts a global environment from an aerial perspective, wherein:
the localized environment is at least a portion of the global environment, and
the localized environment is localized respective to the robot as it generates the sensor data while traversing the localized environment;
generate a localized three-dimensional model depicting the localized environment based upon the sensor data and the odometry data;
generate a localized two-dimensional model of the localized environment that depicts the localized environment from the aerial perspective based upon transforming the localized three-dimensional model;
obtain an indication of an estimated pose of the robot in the localized environment depicted by the localized two-dimensional model;
perform a registration of the localized two-dimensional model with the global two-dimensional model based upon the estimated pose of the robot, wherein the registration generates a transformation function associated with aligning the localized two-dimensional model and the global two-dimensional model;
generate corrected pose data indicating a corrected pose of the robot in the localized environment based upon the transformation function; and
configure the robot using the corrected pose data to identify the corrected pose of the robot within the global environment that differs from the estimated pose.
